(19) United States
(12) Patent Application Publication
(10) Pub. No.: US 2026/0210174 A1
(43) Pub. Date: Jul. 23, 2026

(54) SCREEN ENCLOSURE ACCESS PANEL ASSEMBLY

(71) Applicants: Matthew Kaplan, Palm Beach Gardens, FL (US); Jason Dornbusch, Palm Beach Gardens, FL (US)

(72) Inventors: Matthew Kaplan, Palm Beach Gardens, FL (US); Jason Dornbusch, Palm Beach Gardens, FL (US)

(21) Appl. No.: 19/447,528

(22) Filed: Jan. 13, 2026

Related U.S. Application Data
(60) Provisional application No. 63/747,651, filed on Jan. 21, 2025.

(51) Int. Cl. E06B 5/02

(52) U.S. Cl. CPC E06B 5/02

(57) ABSTRACT

A screen enclosure access panel assembly designed to enable safe, efficient cleaning of rain gutters adjacent to pool screen enclosures. The present invention includes a rectangular aluminum support plate that spans the distance between vertical frame members of the screen enclosure, with a lower end secured to the rain gutter and an upper end attached to the screen panel. A hinged access panel, integrated into the support plate, allows the panel to be opened from within the screen enclosure for direct gutter access without requiring rooftop entry. A latch mechanism secures the panel in the closed position, preventing debris from entering the pool area. By facilitating gutter maintenance from within the enclosure, the present invention eliminates the risks associated with walking on the roof, helps maintain proper drainage, and reduces maintenance costs by preventing gutter blockages and overflow.

### PRIORITY CLAIM

In accordance with 37 C.F.R. 1.76, a claim of priority is included in an Application Data Sheet filed concurrently herewith. Accordingly, the preset invention claims priority to U.S. Provisional Patent Application No. 63/747,651, entitled "SCREEN ENCLOSURE ACCESS PANEL ASSEMBLY", filed January 21, 2025. The contents of the above referenced application are incorporated herein by reference in its entirety.

### FIELD OF THE INVENTION

This present invention relates generally to maintenance of residential pool enclosures and associated rain gutter systems. More specifically, the present invention relates to a system for cleaning gutters positioned between pool screen enclosures and rooflines.

### BACKGROUND OF THE INVENTION

Pool screen enclosures for residential properties are very popular. The enclosures act as a barrier against leaves, bugs, animals from entering the pool area. Screens can filter sunlight, reducing exposure to UV rays and keeping the pool area cooler. Debris including bugs are kept out the pool reducing maintenance costs and lowering chemical demands.

Enclosures add a sense of privacy by creating a semi-secluded area. When equipped with doors and locks, the enclosures provide a level of safety by keeping children and pets away from the pool area. Essentially, the screened enclosure operates like an addition to the home providing an entertainment area. Screened enclosures create a more comfortable, cleaner, and safer pool area, making them a popular choice for pool owners in many regions.

The problem with pool screen enclosures, to which this invention addresses, is the collection of leaves and the like debris at the point where the screen enclosure is secured to the roof line of the residence. The area of concern is the bottom of two sloping surfaces which drain to a rain gutter. Keeping rain gutters clear of leaves is essential for preventing water damage. When gutters are clogged with leaves and debris, rainwater can overflow, causing damage to the roof and fascia. Improper drainage from clogged gutters can undermine the foundation leading to cracks in the foundation and pavement around the pool. The clogged gutter becomes a breeding ground for bugs, mold and mildew. Overflowing gutters can dump excess water into the pool increasing maintenance costs and erode soil and adjoining landscaping.

Cleaning a rain gutter where the screen enclosure meets the roof line is performed by an individual walking on a roof which poses a problem of slipping and falling, which can lead to serious injuries. Roof surfaces can be slippery due to moss, algae, water, or loose debris like leaves. Steep roofs and certain roofing materials can also make it easier to lose footing, especially when the roof is constructed of aluminum. Further, tile and slate roofs are easily damaged from the weight of an individual walking on the roof. What is needed in the industry is a safe way of cleaning gutters between screen enclosures and adjacent roofs that eliminates the need for an individual to walk on the roof of the enclosure.

### SUMMARY OF THE INVENTION

The present invention is a screen enclosure access panel assembly developed to simplify the maintenance of rain gutters in pool screen enclosures. The assembly includes a substantially rectangular aluminum support plate, configured to span the distance between adjacent vertical frame members of a screen enclosure. The support plate is designed for secure attachment to the vertical frames and has an upper and lower end, allowing it to connect securely to both the screen panel above and the rain gutter below. A hinged access panel attached to the support plate opens from inside the pool screen area, providing a direct, safe way to access the rain gutter without requiring roof access.

In the closed position, the access panel functions as a solid barrier, preventing leaves, debris, and pests from entering the pool area through the screen enclosure. A latch element secures the access panel in the closed position, ensuring that it remains firmly shut under normal conditions. When gutter cleaning is required, the access panel can be unlocked and easily moved to the open position, allowing maintenance personnel to clean the gutter directly from within the enclosure, avoiding potential hazards associated with walking on the roof.

An objective of the present invention is to enable pool owners to maintain a clean, efficient gutter system while ensuring the safety of individuals and preserving the integrity of the roof and screen structure.

Another objective of the present invention is to minimize the accumulation of debris within rain gutters near pool screen enclosures, which helps prevent gutter blockages and water overflow that can lead to structural damage, increased maintenance costs, and pest infestations.

It will also be appreciated that various combinations of the features disclosed hereafter for a screen enclosure access panel assembly are also possible as desired.

### BRIEF DESCRIPTION OF THE FIGURES

The present invention is illustrated and described herein with reference to the various drawings, in which like reference numbers are used to denote like system components/method steps, as appropriate, and in which:

FIG. 1 is a perspective view of a screen enclosure access panel assembly in its environment;

FIG. 2 is a perspective view of the screen enclosure access panel assembly;

FIG. 3 is a side view thereof;

FIG. 4 is a top view thereof;

FIG. 5 is a perspective view of another embodiment of the screen enclosure access panel assembly in its environment;

FIG. 6 is a rear perspective view thereof;

FIG. 7 is a side view thereof;

FIG. 8 is a top view thereof;

FIG. 9 is a perspective view of a hinge mechanism; and

FIG. 10 is an enlarged view of the interaction between a hinge receptacle and a hinge insert of FIG. 9.

### DETAILED DESCRIPTION OF THE INVENTION

While the present invention is susceptible of embodiment in various forms, there is shown in the drawings and will hereafter be described a presently preferred, albeit not limiting, embodiment with the understanding that the present disclosure is to be considered an exemplification of the present invention and is not intended to limit the invention to the specific embodiments illustrated.

Referring now to the figures, a screen enclosure access panel assembly 10 is depicted in its intended environment and illustrated in detail. The screen enclosure access panel assembly 10 is designed to be mounted to the structural framework of a typical pool screen enclosure to facilitate safe and efficient maintenance of rain gutters without requiring rooftop access.

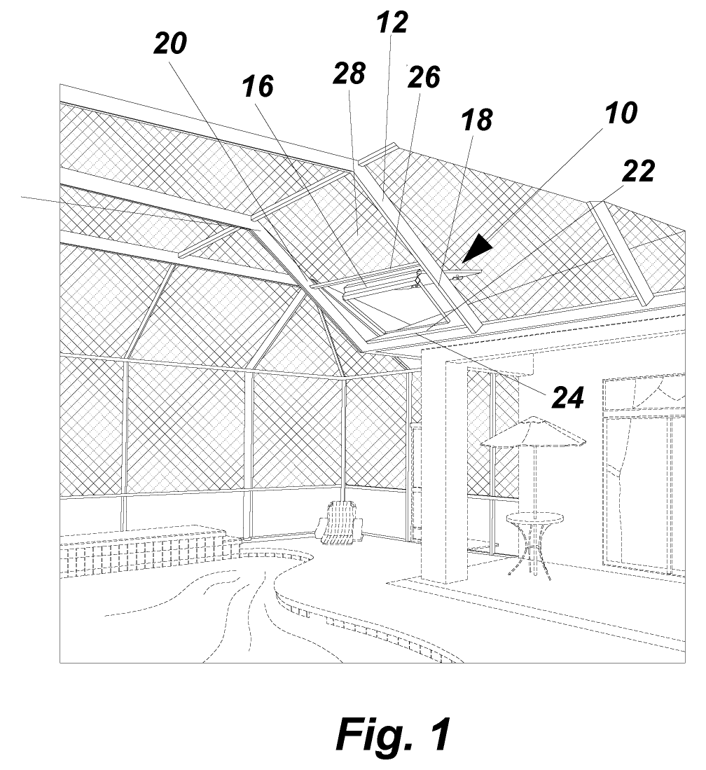

FIG. 1 illustrates a perspective view of the assembly 10 installed between two vertical frame members 12, 14 of a pool screen enclosure. The assembly 10 includes a substantially rectangular aluminum support plate 16, which spans the distance between the adjacent vertical frame members 12 and 14 of the enclosure. The support plate 16 is dimensioned to securely fit within the frame member spacing to ensure stability and compatibility with standard screen enclosure configurations. In particular, the support plate 16 has a first end 18 and a second end 20 spaced apart by a length so that the length is configured to match the distance between adjacent vertical frame members 12, 14 of a screen enclosure for securing the support plate 16 to the vertical frame members 12, 14. A lower end 22 of the support plate 16 is configured for secure attachment to a rain gutter 24, while the upper end 26 is constructed to interface seamlessly with the adjacent screen panel 28 above.

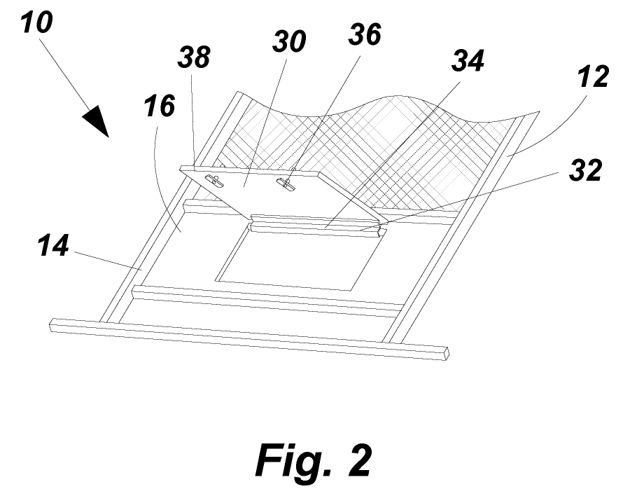

As shown in FIG. 2, the support plate 16 features a hinged access panel 30 integrated along its central portion. The access panel 30 is attached via a hinge mechanism 32 positioned along its first edge 34, allowing the access panel 30 to pivot between an open position and a closed position. In the closed position, the access panel 30 aligns flush with the support plate 16, thus creating a continuous barrier that prevents leaves, debris, and pests from entering the pool area. The use of a latch element 36, affixed near the opposing edge 38 of the access panel 30, ensures that the access panel 30 remains securely closed during normal use and prevents the access panel 30 from opening during high winds and storms.

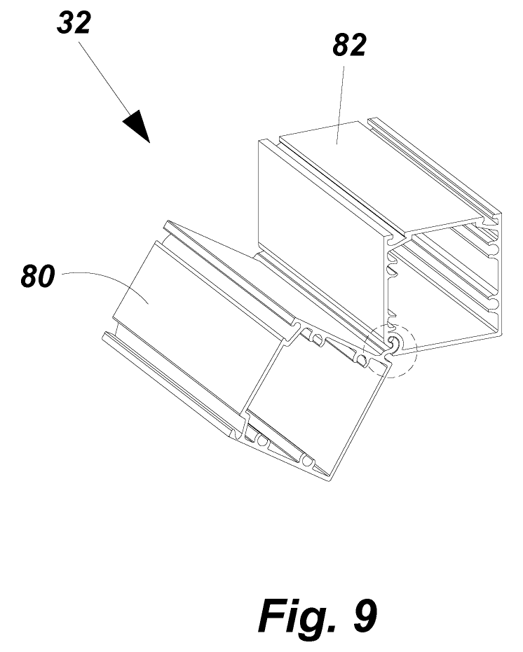

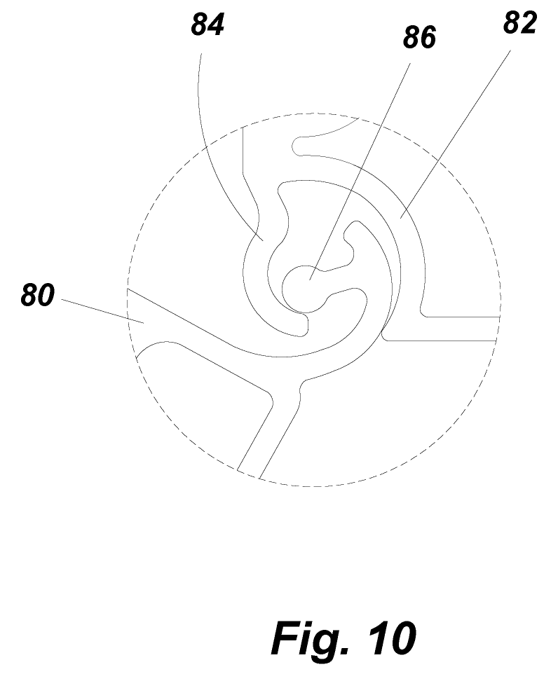

In the illustrated embodiment, the hinge mechanism 32 is detailed in FIGS. 9 and 10. The hinge mechanism 32 includes an elongate hinge insert 80 extending along the first edge 34 of the access panel 30 and a corresponding elongate hinge receptacle 82 formed along the support plate 16. The hinge receptacle 82 defines a curved engagement channel 84 configured to receive a protruding engagement projection 86 of the hinge insert 80. The cooperative curved interface of the hinge insert 80 and hinge receptacle 82 retains the access panel 30 in supported engagement with the support plate 16 while permitting rotation between the open and closed positions. The elongate configuration of the hinge mechanism 32 provides distributed support along the length of the access panel 30 and enhances alignment, stability, and resistance to disengagement under wind loads or vibration. In the present embodiment, the hinge mechanism 32 permits the access panel 30 to pivot outwardly from the support plate 16.

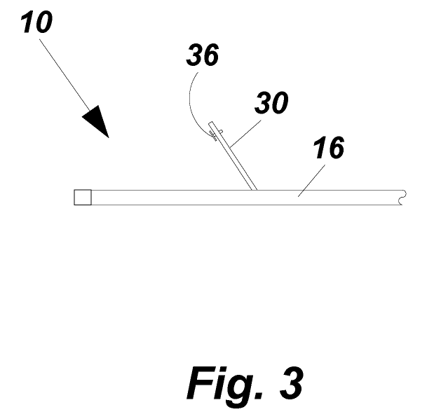

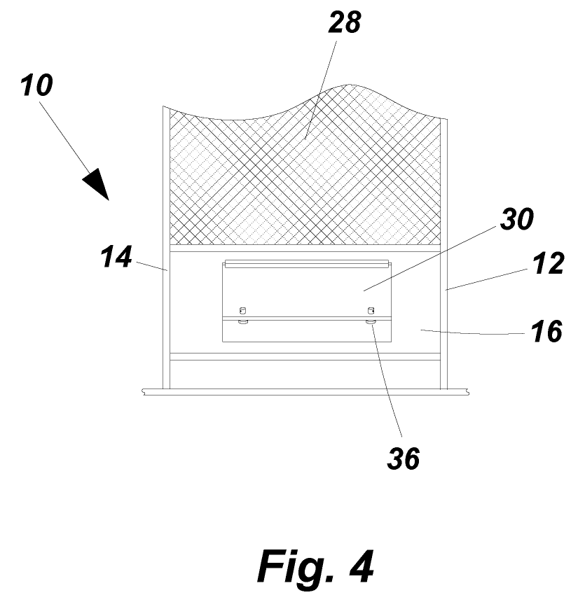

FIG. 3 provides a side view of the screen enclosure access panel assembly 10 in an open position. FIG. 3 shows the angular relationship between the access panel 30 and support plate 16. This configuration allows access to the rain gutter 24 provided from within the pool screen area to allow cleaning of the rain gutter 24. The hinge mechanism 32 allows movement of the access panel 30 when transitioning between the open and closed positions. The assembly 10 is in the open position when the latch element 36 is turned and the access panel 30 is pushed open, as shown in FIG. 3. FIG. 4 illustrates a top-down view of the screen enclosure access panel assembly 10 between the frame member spacing.

In operation, the screen enclosure access panel assembly 10 allows maintenance personnel or the home owner to access the rain gutter 24 safely from within the pool screen area. By disengaging the latch element 36 and pivoting the access panel 30 to the open position, direct access to the rain gutter 24 is provided. This design eliminates the need to walk on the roof, which reduces the risk of falls and roof damage. The aluminum construction of the support plate 16 is also durable and resistant to environmental factors, such as corrosion or deformation over time.

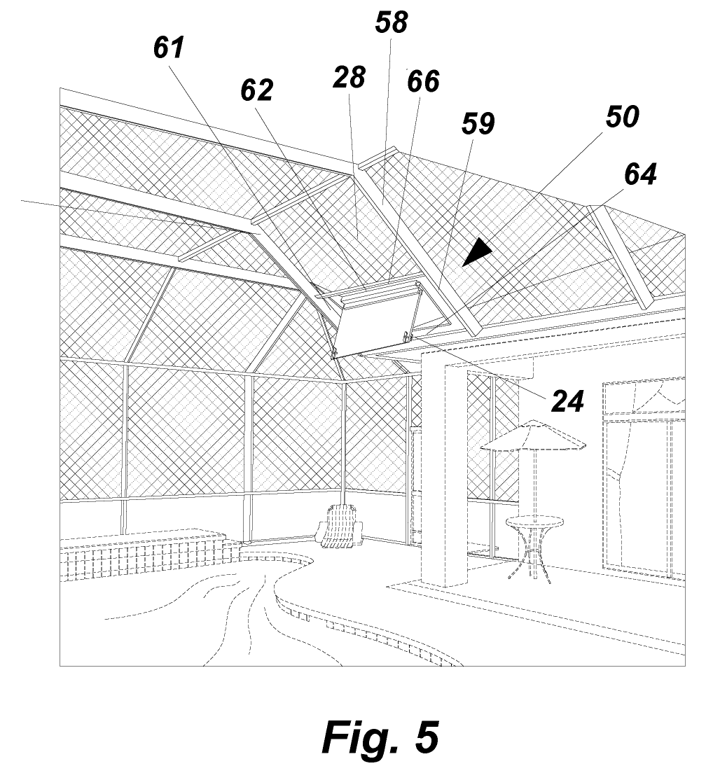

FIGS. 5 through 8 illustrate a second embodiment of the screen enclosure access panel assembly 50, which incorporates the same hinge mechanism 32 described above but arranged such that the access panel 56 pivots inwardly toward the interior of the pool enclosure rather than outwardly. This inward-opening configuration provides an alternative approach to accessing the rain gutter 24 while maintaining the same overall functionality and benefits. The panel 56 itself can be constructed of wire-mesh material, such as that of the screen of the pool enclosure, or of metal such as aluminum. The material of the panel 56 is not limiting.

As shown in FIG. 5, the support plate 62 spans the distance between adjacent vertical frame members 58 and 60, from a first end 59 to a second end 61, in a manner similar to the first embodiment. The support plate 62 includes an upper end 66 constructed and arranged for securement to the screen panel 22 and a lower end 64 configured for securement to the rain gutter 24.

The access panel 56 is integrated into the support plate 62 and has a first edge formed along its lower side. Along this first edge, an elongate hinge insert 80 is formed, extending substantially the entire length of the access panel 56. A corresponding elongate hinge receptacle 82 is provided along the adjacent lower region of the support plate 62. As detailed in FIGS. 9 and 10, the hinge insert 80 includes a protruding engagement projection 86 configured to be received within a curved engagement channel 84 of the hinge receptacle 82. The cooperative curved interface of the hinge insert 80 and hinge receptacle 82 retains the access panel 56 in supported engagement with the support plate 62 while permitting rotation of the access panel 56 between the closed and inwardly open positions.

In the present embodiment, rotation of the access panel 56 about the hinge mechanism 32 causes the access panel 56 to pivot inwardly toward the pool screen area which provides direct access to the rain gutter 24 from inside the enclosure without requiring an individual to walk on the roof or exterior surfaces of the structure. This inward-opening configuration may be preferred in installations where outward clearance is limited or where an inward swing improves ergonomics or access for cleaning tools.

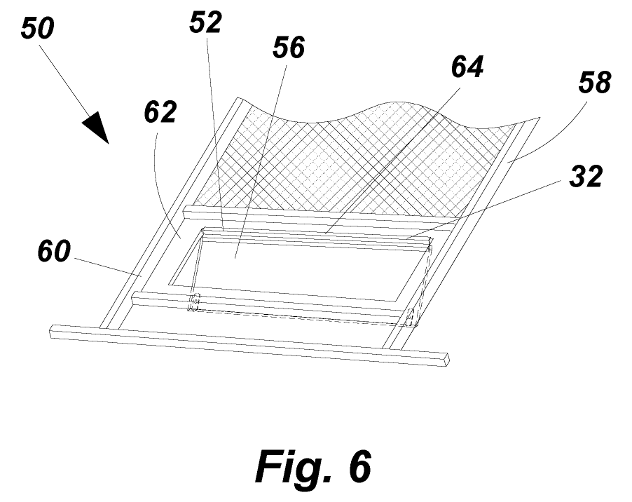

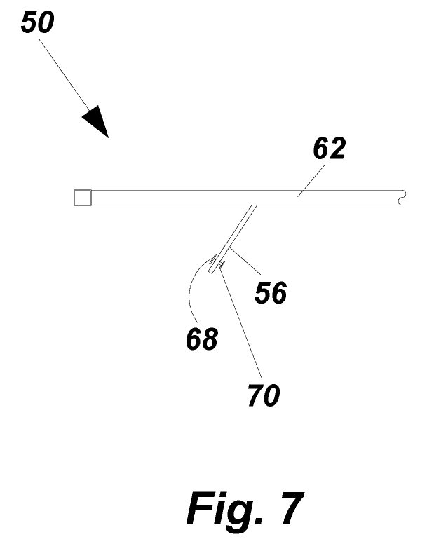

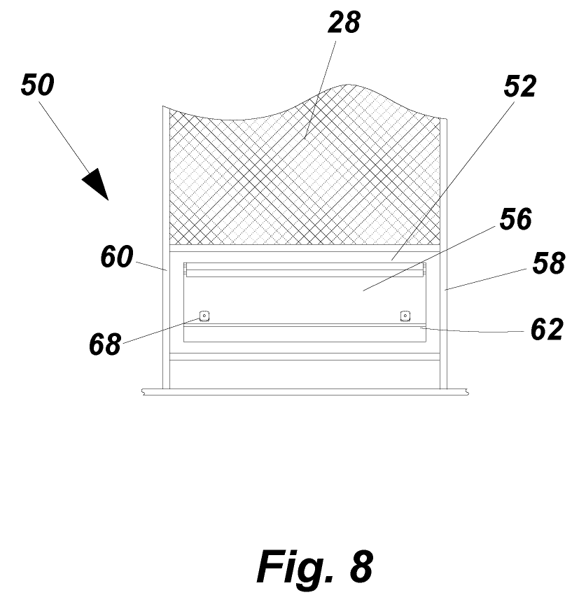

As shown in FIG. 6, the inward rotation provides an unobstructed pathway to the rain gutter 24 and maintains the structural alignment of the access panel 56 during movement. FIG. 7 illustrates the angular relationship of the access panel 56 relative to the support plate 62 in the open position. FIG. 8 provides a top-down view of the assembly 50, demonstrating the integration of the hinge mechanism 32 along the lower edge of the access panel 56.

A latch element 68 is positioned proximate an upper edge 70 of the access panel 56 and secures the access panel 56 in the closed position. During normal operation, the latch element 68 prevents unintended inward rotation of the access panel 56 due to wind, pressure variations, or vibration. The latch is accessible from within the enclosure which permits a user to place the access panel 56 in the inwardly open position for gutter maintenance.

As shown in FIGS. 9 and 10, the hinge mechanism 32 further includes an elongate hinge receptacle 82 and a cooperating elongate hinge insert 80 that together define the articulating connection between the access panel 30 and the support plate 16. The hinge insert 80 is formed along the first edge 34 of the access panel 30 and includes a protruding engagement projection 86. The hinge receptacle 82 is formed along the adjacent region of the support plate 16 and defines a curved engagement channel 84 having a partially enclosed recess sized and shaped to receive the engagement projection 86 of the hinge insert 80.

In one preferred embodiment, the hinge insert 80 and the hinge receptacle 82 are formed of the same material as their respective components and cooperatively interfit without the use of a separate hinge pin or fastener. The hinge insert 80 and hinge receptacle 82 may be formed as integral portions of the access panel 30 and support plate 16, respectively, such that the hinge mechanism 32 provides a continuous, corrosion-resistant articulating interface between the access panel and the support plate.

The curved interface formed between the projection 86 of the hinge insert 80 and the engagement channel 84 of the hinge receptacle 82 retains the access panel 30 in supported engagement with the support plate 16 while permitting smooth rotational movement between the open and closed positions. The cooperating curved geometries also assist in maintaining alignment of the access panel 30 during rotation and resist disengagement under wind loading, vibration, or repeated use.

The elongate configuration of the hinge insert 80 and hinge receptacle 82 extends substantially along the length of the access panel 30, distributing structural loads along the interface and providing increased stability relative to point-based hinge constructions. Although FIGS. 9 and 10 illustrate one preferred implementation of the hinge mechanism 32, variations of the curved engagement profile may be used, provided that the hinge insert 80 remains rotatable within the hinge receptacle 82 while maintained in supported engagement. This same hinge mechanism 32 is used in both embodiments described herein, with the direction of rotation differing depending on installation configuration.

These embodiments provide a straightforward solution for servicing rain gutters from inside a screened enclosure. The hinge mechanism 32 allows the access panel to move predictably and remain properly seated when closed, while the support plate and latch components provide the stability needed for repeated use. Because the assembly installs cleanly into existing framing and can be adapted to different enclosure layouts, it offers a practical option for both residential maintenance and professional service work.

The term "coupled" is defined as connected, although not necessarily directly, and not necessarily mechanically. The use of the word "a" or "an" when used in conjunction with the term "comprising" in the claims and/or the specification may mean "one," but it is also consistent with the meaning of "one or more" or "at least one." The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a method or device that "comprises," "has," "includes" or "contains" one or more steps or elements, possesses those one or more steps or elements, but is not limited to possessing only those one or more elements. Likewise, a step of a method or an element of a device that "comprises," "has," "includes" or "contains" one or more features, possesses those one or more features, but is not limited to possessing only those one or more features.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements, possesses those one or more steps or elements, but is not limited to possessing only those one or more elements. Likewise, a step of a method or an element of a device that “comprises,” “has,” “includes,” or “contains” one or more features, possesses those one or more features, but is not limited to possessing only those one or more features. Furthermore, a device or structure that is configured in a certain way is configured in at least that way, but may also be configured in ways that are not listed.

It is to be understood that while a certain form of the invention is illustrated it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A screen enclosure access panel assembly, comprising:
a substantially rectangular aluminum support plate having a first end and a second end spaced apart by a length, the length being configured to match a distance between adjacent vertical frame members of a screen enclosure for securing the support plate to the vertical frame members, the support plate further having a lower end configured for securement to a rain gutter and an upper end spaced from the lower end by a width, the upper end constructed and arranged to be secured to a screen panel;
an access panel having a first edge;
a hinge mechanism hingedly securing the first edge of the access panel to the support plate, the hinge mechanism comprising an elongate hinge insert formed along the first edge of the access panel and an elongate hinge receptacle formed along the support plate, the hinge insert and the hinge receptacle being formed of the same material and cooperatively interfitting to permit rotation of the access panel between a closed position and an open position;
at least one latch element configured to secure the access panel in the closed position; and
wherein, in the open position, the access panel provides access to the rain gutter from within the pool screen area to allow cleaning of the rain gutter.

2. The screen enclosure access panel assembly of claim 1, wherein the hinge insert and the hinge receptacle are integrally formed with the access panel and the support plate, respectively.

3. The screen enclosure access panel assembly of claim 2, wherein the hinge insert and the hinge receptacle cooperatively interfit without a separate hinge pin or fastener.

4. The screen enclosure access panel assembly of claim 1, wherein the hinge receptacle defines a curved engagement channel and the hinge insert includes a protruding engagement projection configured to be received within the curved engagement channel.

5. The screen enclosure access panel assembly of claim 4, wherein the curved engagement channel includes a partially enclosed recess that retains the engagement projection during movement between the open and closed positions.

6. The screen enclosure access panel assembly of claim 1, wherein the hinge insert and the hinge receptacle extend substantially along the entire length of the first edge of the access panel.

7. The screen enclosure access panel assembly of claim 6, wherein the elongate configuration of the hinge insert and the hinge receptacle distributes structural loads along the interface between the access panel and the support plate.

8. The screen enclosure access panel assembly of claim 1, wherein the access panel comprises a wire-mesh material or an aluminum material.

9. The screen enclosure access panel assembly of claim 1, wherein the access panel is configured to pivot outwardly from the support plate when moved to the open position.

10. The screen enclosure access panel assembly of claim 1, wherein the access panel is configured to pivot inwardly toward the pool screen area when moved to the open position.

11. The screen enclosure access panel assembly of claim 1, wherein the latch element is positioned proximate an edge of the access panel opposite the first edge.
